(19) United States
(12) Patent Application Publication
(10) Pub. No.: US 2007/0142630 A1
(43) Pub. Date: Jun. 21, 2007

(54) QUATERNARY AMMONIUM BETAINES FOR PROTECTION OF WOOD STRUCTURES

(75) Inventors: Joe D. Sauer, Baton Rouge, LA (US); George W. Cook JR., Baton Rouge, LA (US); Christoper S. Knight, Prairieville, LA (US); Edmund F. Perkins JR., Baton Rouge, LA (US)

Correspondence Address: EDGAR SPIELMAN;ALBEMARLE CORPORATION, 451 FLORIDA BLVD., BATON ROUGE, LA, 70801, US

(73) Assignee: Albemarle Corporation, Baton Rouge, LA (US)

(21) Appl. No.: 11/613,742

(22) Filed: Dec. 20, 2006

Related U.S. Application Data
(60) Provisional application No. 60/752,436, filed on Dec. 20, 2005.
(60) Provisional application No. 60/752,326, filed on Dec. 20, 2005.
(60) Provisional application No. 60/864,619, filed on Nov. 7, 2006.
(60) Provisional application No. 60/864,620, filed on Nov. 7, 2006.

(51) Int. Cl. C07F 5/00

(52) U.S. Cl. 534/12

(57) ABSTRACT

The present invention relates to cellulosic substrates in direct or indirect contact with the ground, the cellulosic substrates comprising quaternary ammonium compounds.

### CROSS-REFERENCE TO RELATED APPLICATIONS

The present application claims priority to U.S. Provisional Application No. 60/752,436 and U.S. Provisional Application No. 60/752,326, both filed Dec. 20, 2005; U.S. Provisional Application No. 60/864,619, filed Nov. 7, 2006; and U.S. Provisional Application No. 60/864,620, filed Nov. 7, 2006; all of which are hereby incorporated by reference in their entirety.

### FIELD OF THE INVENTION

The present invention relates to cellulosic substrates comprising quaternary ammonium compounds.

### BACKGROUND OF THE INVENTION

A class of molecules referred to as quaternary compounds or “quats” for short find use in many industrial applications. Quats are loosely defined as a group of compounds in which a nitrogen atom is joined to four organic radicals. Typically, but not always, one of the radicals is a long-chain alkyl group. In most industrial applications, these quat molecules are complexed with a counter ion (anion) to provide for an “active” molecule.

Industries that quats find utility in range from the wood preservative/biocide industry to such industries as hair care products, cleaning products, fabric softeners, pharmaceuticals, surfactants, deodorants, mouthwashes, preservatives, emulsifiers, cosmetics, and ore mining. Of special interest is the use of these quats as wood preservatives.

### SUMMARY OF THE INVENTION

The present invention relates to:
a) a cellulosic substrate; and
b) at least one quaternary ammonium compound having the formula:

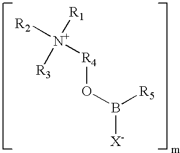

wherein:
i) X is selected from elements having a net ionic charge of −2;
ii) R₁, R₂, R₃, and R₄ are selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups;
iii) R₅ is selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups or OH;
iv) m is 1, 2, or 3; and
v) said substrate is in direct or indirect contact with the ground.

In another embodiment the present invention relates to:
a) a cellulosic substrate; and
b) at least one quaternary ammonium compound having the formula:

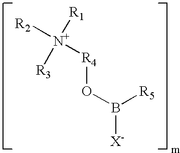

wherein R₁, R₂, R₃, and R₄ are selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; m is 1, 2, or 3; R₅ is selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups or OH; and X is selected from elements having a net ionic charge of −2; and said substrate is in direct or indirect contact with the ground.

### DETAILED DESCRIPTION OF THE INVENTION

The terms “microbial”, “microbe” and “microbial organism” can be used interchangeably herein and are used herein in the broadest sense and are meant to include one or more of the following: molds, mildews, funguses, and the like.

Also, “building” as used herein is also used in its broadest sense and is meant to include homes, office and/or other commercial buildings, storage units or buildings, apartments, mobile homes, travel trailers, detached garages, camps, and the like.

Quaternary Ammonium Compound

It should be noted that the term “quaternary ammonium compound”, “quat”, or “boron-quat” as used herein refers to a compound in which at least one nitrogen atom is joined to four organic radicals leaving a net positive charge. In certain aspects, the organic radicals can be alkyl or alkenyl (unsaturated alkyls) groups that are linear or branched, substituted or unsubstituted, or mixtures thereof. In other aspects, the term “quaternary ammonium compound” or “quat” is also intended to encompass a compound in which more than one nitrogen is joined to four organic radicals. For example, one of the four organic radicals of a quat may be a “shared” radical with a second quat.

Generally, the quaternary ammonium compounds used in the present invention can be represented by the formula:

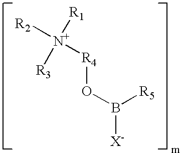

wherein m can be 1, 2, or 3, and X is selected from an element having a net ionic charge of −2, sometimes oxygen (“O”).

The boron-containing quats according to the present differ from those previously disclosed in the art in that they are not complexed with a counter anion. Instead, boron, the active species imparting the desired properties to the quat, is a part of the quat molecule, and the anion X providing the ionic charge necessary to provide for a quat having a net ionic charge of 0, which can be suitably selected from elements having a net ionic charge of −2, in some embodiments oxygen, is also part of the boron-containing quat molecule. While not wishing to be bound by theory, the inventors hereof believe that this provides for a more effective quat molecule than previously disclosed because the quat itself has a net ionic charge of zero without the need for a counter anion. Further, the counter anion, the active species imparting the desired properties to the quat, in previously disclosed quats, was held by an ionic bond. However, in the present case, the bond between the boron active species and the quat molecule is a covalent bond. The inventors hereof theorize that exposure to the elements, i.e. wind, rain, washing, pressure washing, etc., of a substrate treated with a quat complexed with a counter anion could cause the ionic bond between the active species, e.g. carbonate, bi-carbonate, etc., to break and another species to be substituted for the active species. For example, in the case of excessive washing with salt water, a Cl⁻ ion from the salt in the water may be substituted for the active species complexed with the quat, thus causing the quat to lose its desired characteristics. However, in the case of the quats according to the present invention the active species is held to the quat by a covalent bond, thus excessive washing would not cause this substitution.

The five carbon chains, i.e. R₁, R₂, R₃, R₄, and R₅ of the quats used in the present invention are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups. Alkyl and alkenyl groups suitable for use in the quats are those that contain in the range of from 1 to 20 carbon atoms. In some embodiments, R₁, R₂, and R₄ are independently chosen from alkyl groups having in the range of from 1 to 3 carbon atoms, and R₃ are independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, or 3. In another embodiment, R₁ and R₂ are methyl groups, R₃ is chosen from alkyl groups having in the range of from 1 to 3 carbon atoms, and R₄ is selected from unsubstituted alkyl groups containing in the range of from 8 to 14 carbon atoms. In one embodiment, R₃ is an unsubstituted alkyl group containing in the range of from 8 to 10 carbon atoms, and R₃ is an ethyl group. In still other embodiments, R₁, R₂, R₃ and R₄ are alkyl groups having in the range of from 1 to 3 carbon atoms, sometimes methyl groups. In some of these embodiments, R₅ is OH.

In other embodiments of the present invention R₄, is selected from i) substituted or unsubstituted alkyl groups that contain from 13 to 16, sometimes 14 to 16, sometimes 14, carbon atoms or ii) substituted or unsubstituted alkenyl groups that contain from 13 to 16, sometimes 14 to 16, sometimes 14, carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups. These carbon chains can be saturated or unsaturated, preferably unsubstituted. In some embodiments, R₃ can be selected from unsaturated substituted or unsubstituted, preferably unsubstituted, alkyl groups containing from 13 to 16, sometimes 14 to 16, sometimes 14, carbon atoms. In some of these embodiments, R₁, R₂, and R₄ are independently chosen from alkyl groups having from 1 to 4, sometimes 1 to 3, in some embodiments 2 to 4, carbon atoms. In some of these embodiments, R₅ is OH.

In another embodiment, m is 2, and one of the four organic radicals of a quat may be a “shared” radical with a second quat. It should be noted that while in this embodiment R₄ is shown as the shared radical, the shared radical can be any of R₁, R₂, R₃, or R₄. In this embodiment, the quaternary ammonium compounds used in the practice of the present invention have the general formula:

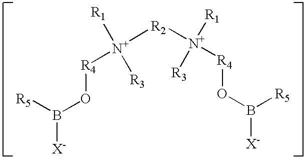

In this embodiment, each R₁, R₂, R₃, R₄, and R₅, are as described above, and each X is selected from those elements having an ionic charge of −2, in some embodiments each X is O.

In another embodiment m is 3, and one of the four organic radicals of a quat is a “shared” radical with a second quat. In this embodiment, the quaternary ammonium compounds used in the practice of the present invention can have the general formula:

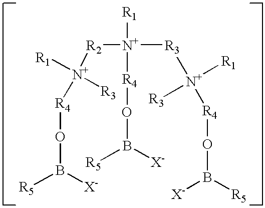

In this embodiment, each R₁, R₂, R₃, R₄, R₅, and X are as described above. It should be noted that while in this embodiment R₂ and R₃ are shown as shared radicals, the shared radicals can be any of R₁, R₂, R₃, or R₄.

The quats of the present invention can be prepared by any methods known in the art, exemplary methods include those described in commonly-owned co-pending applications PCT US2005/010162 and U.S. 60/730,821, which are incorporated herein by reference in their entirety.

Cellulosic Substrate

Cellulosic substrate as used herein is meant to refer to wood, cotton, cardboard, liner board; other similar paper products; paper “coverings” on wall boards such as gypsum board; ceiling tile materials; bagasse; composite assemblies; particleboard or other similar composite or engineered material used in the construction of a building, i.e. fiber board, press-board, and the like; any other material made of cellulose, any combinations thereof; and the like. In some embodiments, the cellulosic substrate is wood, or particleboard or other similar composite or engineered wood material used in the construction of a building, i.e. fiber board, press-board, and the like.

In the present invention, the cellulosic substrates are in direct contact with the ground, i.e. soil; in other embodiments, the cellulosic substrates are in indirect contact with the ground. Indirect contact as used herein is meant that the cellulosic substrate may be on top of, for example, a cement or similar pad or slab for a building, may be roof beam of a building wherein the wooden or metal studs of the building are in contact with the ground or a slab, etc. In some embodiments, the cellulosic substrate is a part of a building, sometimes a building in construction and sometimes a completed building. In some embodiments, the cellulosic substrate is in an environment conducive to the presence, growth, and/or sustainability of termites. In other embodiments, the building is in an environment conducive to the presence, growth, and/or sustainability of termites and/or microbial organisms.

The cellulosic substrate(s) can be treated or impregnated with the quats of the present invention according to any method known in the art. Non-limiting examples of ways of treating and/or impregnating substrates include dipping, soaking, brushing, pressure treating, and the like. The length of treatment time will vary according to the treatment method selected, the substrate, and the desired properties. Treatment times are readily selectable by one having ordinary skill in the art.

However, all treatments generally involve treating the cellulosic substrate with an aqueous solution comprising the quat(s) until the treated cellulosic substrate comprises an effective amount of the quat(s). By an effective amount, it is meant that the treated cellulosic substrate comprises from about 1 to about 30 wt. %, based on the weight of the treated cellulosic substrate, of the quat(s). In preferred embodiments, the treated cellulosic substrate comprises from about 5 to about 10 wt. % of the quat(s), on the same basis.

In the practice of the present invention the aqueous solution used in the treatments of the cellulosic substrate is metal coupler free. By metal coupler free, it is meant that the aqueous solution does not contain metals such as copper, mercury, lead, cadmium, hexavalent chromium, arsenic, antimony, or zinc. These metals are commonly used for their biocidal properties. However, these and other “heavy” metals pose certain environmental concerns, thus, it would be beneficial to provide a treated cellulosic material that does not contain these heavy metals. By this, it is meant that the treated cellulosic material does not contain heavy metals that are not naturally present in the cellulosic material, i.e. these heavy metals are not added to the cellulosic material but may naturally be present in the cellulosic material.

The processes used in the production of quats, for example those described in commonly-owned co-pending applications PCT US2005/010162 and U.S. 60/730,821, typically produce quats in an aqueous solution. The aqueous solution typically comprises water, at least one polar organic co-solvent, and one or more quats, as described herein. These aqueous solutions generally have a polar organic co-solvent to water ratio in the range of from about 10:90 up to about 99:1 (wt. co-solvent:wt. water based on the combination of the water and polar organic co-solvent), and the exact amount of the polar organic co-solvent and water is selected according to the selection of R₁, R₂, R₃ and R₄. In general, it is preferred that the ratio of co-solvent:water, by weight and on the same basis, is within the range of from about 50:50 to about 99:1, about 60:40 to about 99:1 is more preferred, about 70:30 to about 98:2 is even more preferred, and about 80:20 to about 95:5 is yet more preferred.

It has generally been found that aqueous solutions having a higher ratio of co-solvent to water are preferred for quats containing very hydrophobic alkyl substituent groups, e.g., double tailed or twin tailed quats where the alkyl groups are C₁₀-C₂₀, for example, while aqueous solutions having a lower ratio of co-solvent to water are preferred for boron-quats having less hydrophobic alkyl substituent groups, e.g., a (C₂-C₆) alkyltrimethylammonium salt.

It should be understood that the aqueous solutions comprise water, at least one polar organic co-solvent and the quat(s) according to the present invention. However, when describing the amount of water and polar organic co-solvent in the aqueous solution above, these ratios were based on the amount of polar organic co-solvent and water. Thus, when considering the amounts of these components and the quat in the prophylactic solution, the mixture is a ternary composition comprising at least three major components, water, polar organic co-solvent, and the quat “salt”. Thus, the ratio of the components of the aqueous solution can be represented as a ratio of wt. quat: wt. polar organic co-solvent: wt. water, based on the aqueous solution. By way of example, an aqueous solution formed by adding 25% by weight of a quat salt to a mixture comprising an 85:15 by weight mixture of methanol: water, would have a ternary composition, by weight, of 25:64:11, quat salt: methanol: water by weight, based on the aqueous solution.

Because of economic and/or process considerations the quats are generally produced in an aqueous solutions generally have a concentration of quat(s) ranging from about 1 to about 50 wt. % quat, based on the aqueous solution. If the quat concentration of the aqueous solution is in the range of from about 1 to about 10 wt. %, based on the aqueous solution, then the aqueous solutions can be applied to the cellulosic substrate as is, but these aqueous solutions are generally only available commercially with quat concentrations in the range of from about 10 to about 30 wt. %, based on the aqueous solution, of the quat(s), more typically in the range of from about 20 to about 30 wt. %, on the same basis. The inventors hereof have discovered that quat(s) concentrations this high are not necessary and ranges much lower are effective and less costly at producing a treated cellulosic substrate containing an effective amount of quat(s), as described above. Thus, in the practice of the present invention, a diluent can be added to the aqueous solution to reduce the quat concentration of the aqueous solution to within the range of from about 1 to about 10 wt. %, in some embodiments in the range of from about 2 to about 8 wt. %, and in some embodiments in the range of about 4 to about 6 wt. %, all based on the aqueous solution. Diluents suitable for use herein can be selected from polar organic co-solvents, as described above, water, and mixtures thereof. In some embodiments, the diluent is water.

Alternative Quaternary Ammonium Compounds

In some embodiments, one, in some embodiments more than one, quaternary ammonium compound(s) having the formula below can be used: 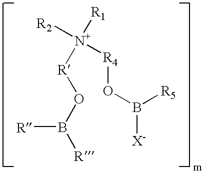
wherein R₁, R₂, R₄, R₅, X, and m are as described above, R′ is a hydrocarbon group having from 1-10 carbon atoms, in some embodiments in the range of from 1 to 5, in some embodiments in the range of from 1 to 3, and R″ and R′″ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups. In some embodiments R″ and R′″ are selected from unsubstituted alkyl groups having in the range of from 1 to 20 carbon atoms, in some embodiments in the range of from 1 to 15, and in other embodiments in the range of from 6 to 14.

The above description is directed to several embodiments of the present invention. Those skilled in the art will recognize that other embodiments, which are equally effective, could be devised for carrying out the spirit of this invention. It should also be noted that embodiments of the present invention contemplate that all ranges discussed herein include ranges from any lower amount to any higher amount.

What is claimed is:

1) A composition comprising:
a) a cellulosic substrate; and
b) at least one quaternary ammonium compound having the formula: 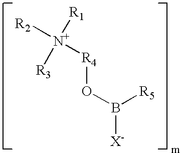
wherein:
i) X is selected from elements having a net ionic charge of −2;
ii) R₁, R₂, R₃, and R₄ are selected from i) substituted or unsubstituted alkyl groups containing in the range of from 1 to 20 carbon atoms or ii) substituted or unsubstituted alkenyl groups containing in the range of from 1 to 20 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
iii) R₅ is selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups or OH;
iv) m is 1, 2, or 3; and
v) said cellulosic substrate is in direct or indirect contact with the ground.

2) The composition according to claim 1 wherein said composition comprises in the range of from about 1 to about 30 wt. %, based on the weight of the composition, of the at least one quaternary ammonium compound.

3) The composition according to claim 2 wherein X is O and R₅ is OH.

4) The composition according to claim 2 wherein R₁, R₂, and R₄ are independently chosen from alkyl groups having in the range of from 1 to 3 carbon atoms, and R₃ is independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups and R₅ is OH.

5) The composition according to claim 2 wherein R₁ and R₂ are methyl groups, R₄ is an ethyl group, R₃ is selected from unsubstituted alkyl groups containing from 8 to 16 carbon atoms, and R₅ is OH.

6) The composition according to claim 2 wherein R₃ is an unsubstituted alkyl group containing in the range of from 8 to 10 carbon atoms or an unsubstituted alkyl group containing in the range of from 12 to 16 carbon atoms, R₁, R₂, and R₄ are independently selected from unsubstituted alkyl groups containing in the range of from 1 to 3 carbon atoms; and R₅ is OH.

7) The composition according to claim 2 wherein R₃ is an unsubstituted alkyl group containing from 8 to 10 carbon atoms or an unsubstituted alkyl group containing in the range of from 12 to 14 carbon atoms; R₁, R₂, and R₄ are independently selected from unsubstituted alkyl groups containing in the range of from 1 to 3 carbon atoms; and R₅ is OH.

8) The composition according to claim 1 wherein at least one of R₁, R₂, R₃, and R₄ is a shared radical.

9) The composition according to claim 8 wherein m is 2, and the at least one quaternary ammonium compound has the general formula: 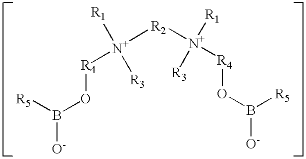
wherein each R₁, R₂, and R₄ is independently selected from i) substituted or unsubstituted alkyl groups containing in the range of from 1 to 3 carbon atoms; or ii) substituted or unsubstituted alkenyl groups, wherein if i) or ii) is substituted, each R₃ is independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and each R₅ is independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups or OH.

10) The composition according to claim 8 wherein m is 3 and said at least one quaternary ammonium compound has the formula: 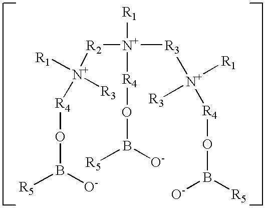
wherein each R₁, R₂, and R₄ are independently selected from i) substituted or unsubstituted alkyl groups containing in the range of from 1 to 3 carbon atoms; or ii) substituted or unsubstituted alkenyl groups, wherein if i) or ii) is substituted, each R₃ is independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and each R₅ is independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups or OH.

11) The composition according to claim 1 wherein said at least one quaternary ammonium compound has the formula: 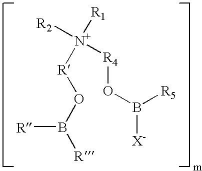
wherein said at least one quaternary ammonium compound is metal coupler free; R₁, R₂, and R₄ are independently selected from i) substituted or unsubstituted alkyl groups containing in the range of from 1 to 3 carbon atoms; or ii) substituted or unsubstituted alkenyl groups, wherein if i) or ii) is substituted, R₃ is independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; R₅ is independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups or OH; and each X is O; R′ is a hydrocarbon group having from 1-10 carbon atoms; and R″ and R′″ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups.

12) The composition according to claim 1 wherein said composition is part of a building in any stage of its construction.

13) The composition according to claim 3 wherein said composition is part of a building in any stage of its construction.

14) The composition according to claim 11 wherein said composition is part of a building in any stage of its construction.

15) The composition according to claim 1 wherein said composition is a part of or present in a completed building.

16) The composition according to claim 3 wherein said composition is a part of or present in a completed building.

17) The composition according to claim 11 wherein said composition is a part of or present in a completed building.

18) The composition according to any of claims 12-17 wherein said cellulosic substrate is selected from wood; cotton; cardboard, liner board or other similar paper products; paper “coverings” on wall boards such as gypsum board; ceiling tile materials; bagasse; composite assemblies; particleboard or other similar composite or engineered material used in the construction of a building; fiber board, press-board, and the like; any other material made of cellulose, any combinations thereof, and the like.

19) The composition according to claim 18 wherein the composition is termite repellant and/or flame retardant.

20) A building comprising cellulosic substrates wherein said building is present in an environment conducive to the presence, growth, and/or sustainability of termites and wherein the cellulosic substrates of the building comprise in the range of from about 1 to about 30 wt. %, based on the cellulosic substrate, of at least one quaternary ammonium compound having the formula: 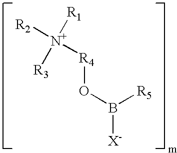
i) X is selected from elements having a net ionic charge of −2;
ii) R₁, R₂, R₃, and R₄ are selected from i) substituted or unsubstituted alkyl groups containing in the range of from 1 to 20 carbon atoms or ii) substituted or unsubstituted alkenyl groups containing in the range of from 1 to 20 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
iii) R₅ is selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups or OH; and
iv) m is 1, 2, or 3.

21) The building according to claim 20 wherein said cellulosic substrates are in direct or indirect contact with the ground.

22) The building according to claim 20 wherein X is O and R₅ is OH.

23) The building according to claim 20 wherein said cellulosic substrates are termite repellant.

24) The building according to claim 20 wherein R₁, R₂, and R₄ are independently chosen from alkyl groups having in the range of from 1 to 3 carbon atoms, and R₃ is independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups and R₅is OH.

25) The composition according to claim 20 wherein R₁ and R₂ are methyl groups, R₄ is an ethyl group, R₃ is selected from unsubstituted alkyl groups containing from 8 to 16 carbon atoms, and R₅ is OH.

26) The composition according to claim 20 wherein R₃ is an unsubstituted alkyl group containing in the range of from 8 to 10 carbon atoms or an unsubstituted alkyl group containing in the range of from 12 to 16 carbon atoms, R₁, R₂, and R₄ are independently selected from unsubstituted alkyl groups containing in the range of from 1 to 3 carbon atoms; and R₅ is OH.

27) The composition according to claim 20 wherein R₃ is an unsubstituted alkyl group containing from 8 to 10 carbon atoms or an unsubstituted alkyl group containing in the range of from 12 to 14 carbon atoms; R₁, R₂, and R₄ are independently selected from unsubstituted alkyl groups containing in the range of from 1 to 3 carbon atoms; and R₅ is OH.

28) The composition according to claim 20 wherein at least one of R₁, R₂, R₃, and R₄ is a shared radical.
